(19) United States
(12) Patent Application Publication
(10) Pub. No.: US 2003/0137837 A1
(43) Pub. Date: Jul. 24, 2003

(54) Dual source lighting fixture

(75) Inventors: Neall W. Humphrey, El Dorado Hills, CA (US); Leslie D. Humphrey, El Dorado Hills, CA (US)

Correspondence Address: HAYNES AND BOONE, LLP, 901 MAIN STREET, SUITE 3100, DALLAS, TX, 75202, US

(73) Assignee: Craftmade International, Inc., Coppell, TX

(21) Appl. No.: 10/056,775

(22) Filed: Jan. 24, 2002

(51) Int. Cl. F21S 9/00; F21S 19/00

(52) U.S. Cl. 362/228; 362/249

(57) ABSTRACT

Method and apparatus are described for a lighting fixture for providing a lighting source of a first wattage range and a lighting source of a second wattage range, wherein the lighting sources may be activated simultaneously or independently, depending on the desired illumination level.

This invention relates to a lighting fixture that comprises a lighting source of a first wattage range and a lighting source of a second wattage range.

### DESCRIPTION OF THE DRAWINGS

FIG. 1 is a bottom perspective view of an embodiment of a lighting fixture according to the present invention.

FIG. 2 is a bottom plan view of the lighting fixture.

FIG. 3 is a front elevational view of the lighting fixture.

FIG. 4 is a side view of an alternative embodiment of the present invention.

### DESCRIPTION

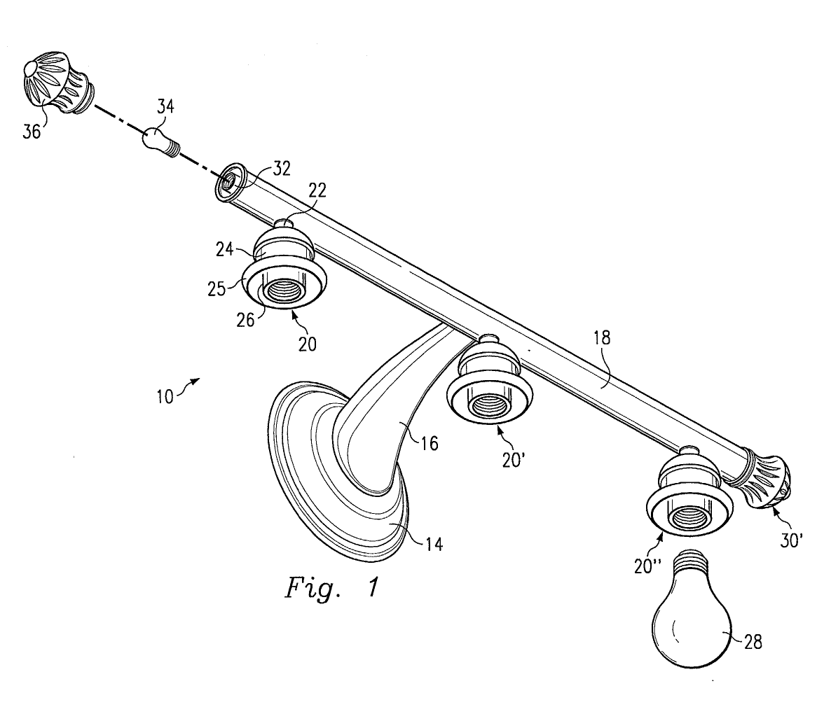

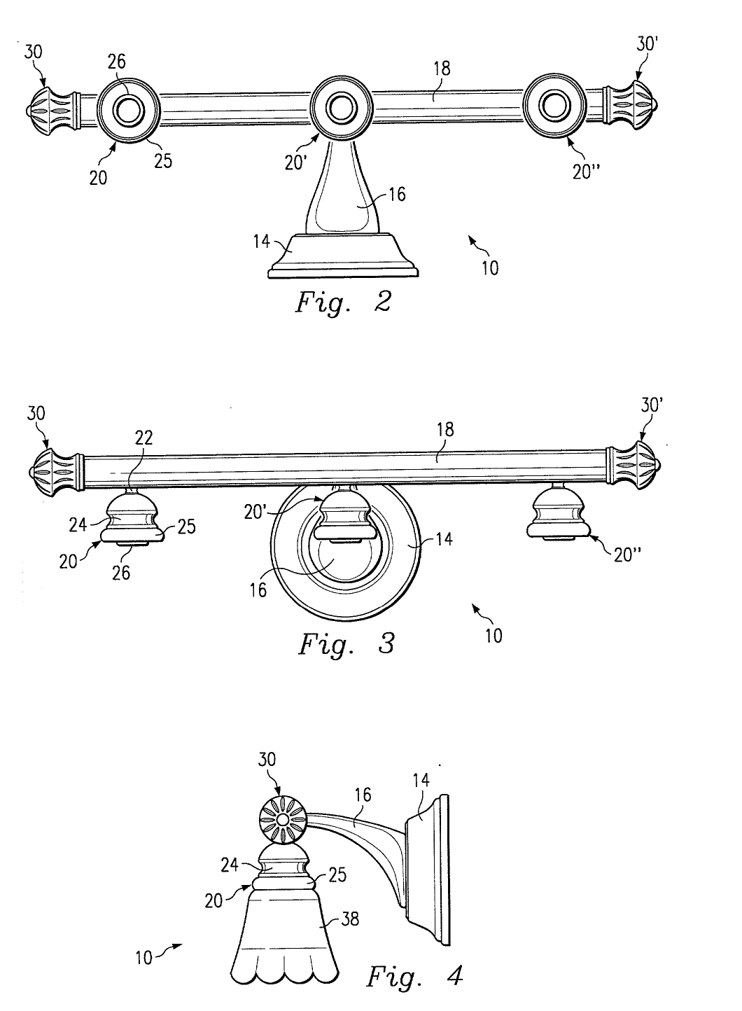

Referring to FIGS. 1-3, a lighting fixture according to one embodiment of the present invention is given the reference numeral 10. It is understood that the lighting fixture 10 retains all necessary conventional electrical components for the fixture to function as a commercial or residential lighting source, including meeting applicable industry and governmental standards.

The lighting fixture 10 comprises a base 14 which retains conventional mechanical attachment means well known by those skilled in the art. The base 14 may be attached to a surface (not shown), such as a wall, for mounting the lighting fixture. It is understood that the base 14 also retains conventional wiring for supplying electricity from a conventional source to the lighting fixture 10, as will be described below. Furthermore, it is understood that a conventional switching means is operably connected to the lighting fixture 10 to control the flow of electricity to the fixture.

An arm 16 is affixed to the base 14. The arm 16 is operably connected to the base 14, and hence also retains conventional wiring for supplying electricity to the lighting fixture 10. A light bar 18 attaches to the arm 16, the arm spacing the light bar from the base 14, and hence the wall.

A lighting assembly 20 is affixed to the light bar 18, and is operably connected to the wiring of the arm 16 and the base 14. When supplied with electricity, the lighting assembly 20 provides a lighting source of a first wattage range. The first wattage range is for light bulbs 25W to 100W, and is suitable for general illumination. Substantially similar lighting assemblies 20′ and 20″ may also be affixed to the light bar 18 for providing additional lighting sources of the first wattage range. As the lighting assemblies 20′ and 20″ are substantially similar to the above-described lighting assembly 20, they will not be described in detail.

The lighting assembly 20 attaches to the light bar 18 via a pedestal 22. A housing 24 is attached to the pedestal 22, the housing having a rim 25. A light socket 26 is disposed in the housing 24, the housing providing an aesthetic and protective covering for the socket. The base 14, arm 16, light bar 18, and pedestal 22 may be hollow to provide a passage for wiring to be supplied to the light socket 26.

It is understood that the light socket 26 is a medium base, also referred to as a standard base or Edison base. A conventional light bulb 28 is disposed in the light socket 26.

A lighting assembly 30 is also attached to the light bar 18 at a distal end of the light bar, and is operably connected to the wiring of the arm 16 and the base 14. When supplied with electricity, the lighting assembly 30 provides a lighting source of a second wattage range. The second wattage range is for light bulbs 4W to 7W, and is suitable for special purposes illumination, such as a night light. A night light is a well known term of art in the industry. Generally, it refers to a low wattage light that is left on in dark conditions to sufficiently illuminate an area to guide, or allow navigation of a room by, a user without being obtrusive. A similar lighting assembly 30′ may be disposed at the other distal end of the light bar 18 for providing an additional lighting source of the second wattage range.

The lighting assembly 30 comprises a light socket 32 and a conventional light bulb 34. It is understood that the light socket 32 is a candelabra base. A decorative globe 36 is connected to the lighting assembly 30 to provide an aesthetic covering for the light bulb 34. The globe 36 may screw into the distal end of the light bar 18, or may be affixed by any conventional means.

In one embodiment, illustrated in FIG. 4, a decorative globe 38 is connected to the lighting assembly 20 via the rim 25 by any conventional means. It is understood that the additional lighting assemblies 20′ and 20″ may also have decorative globes. It can be appreciated that the globe 38 may be of any decorative shape, and the rim 25 of a diameter consistent to interact with standard globe base diameters in the industry.

In operation, the conventional switching means associated with the lighting fixture 10 enables a user to choose between four lighting settings by selectively activating the lighting assembly 20 and the lighting assembly 30. The user determines a desired illumination level, and then selects a lighting setting.

The first setting activates only the lighting assembly 20, thus generally illuminating an area adjacent to the fixture 10.

The second setting activates both lighting assemblies 20 and 30, thus also generally illuminating an area adjacent to the fixture 10. It is understood that due to the nature of the first and second wattage ranges, the second setting may not provide perceptibly greater illumination than the first setting.

The third setting activates only the lighting assembly 30, thus providing a night light in an area adjacent to the fixture 10.

Finally, the fourth setting activates neither the lighting assembly 20 nor 30. In practice, this may be a default setting.

In an alternative embodiment, not depicted, the fixture 10 contains two lighting assemblies substantially similar to the above-described lighting assembly 20. In another alternative embodiment, the fixture 10 contains four lighting assemblies substantially similar to the above-described lighting assembly 20. In a further alternative embodiment, the fixture 10 contains five lighting assemblies substantially similar to the above-described lighting assembly 20.

Although only a few exemplary embodiments of this invention have been described in detail above, those skilled in the art will readily appreciate that many modifications are possible in the exemplary embodiments without materially departing from the novel teachings and advantages of this invention. For example, the lighting fixture 10 may comprise a variety of shapes. The fixture 10 may have any number of lighting assemblies similar to lighting assembly 20, and oriented in a variety of orientations. Accordingly, all such modifications are intended to be included within the scope of this invention as defined in the following claims.

1. A lighting fixture, comprising:
a base;
an arm extending from the base;
a light bar attached to the arm and spaced from the base by the arm;
a first lighting assembly attached to the light bar, and having a first wattage range; and
a second lighting assembly attached to the light bar, and having a second wattage range.

2. The fixture of claim 1 wherein the first wattage range is 25W to 100W.

3. The fixture of claim 1 wherein the second wattage range is 4W to 7W.

4. The fixture of claim 1 wherein the first lighting assembly has a medium base socket.

5. The fixture of claim 1 wherein the second lighting assembly has a candelabra base socket.

6. The fixture of claim 1 further comprising a decorative globe.

7. The fixture of claim 1 wherein the second lighting assembly is disposed at a distal end of the light bar.

8. A lighting fixture, comprising:
a base;
an arm extending from the base;
a light bar attached to the arm and spaced from the base by the arm;
a first lighting assembly attached to the light bar, and having a first wattage range of 25W to 100W; and
a second lighting assembly attached to the light bar, and having a second wattage range of 4W to 7W.

9. The fixture of claim 8 wherein the first lighting assembly has a medium base socket.

10. The fixture of claim 8 wherein the second lighting assembly has a candelabra base socket.

11. The fixture of claim 8 further comprising a decorative globe.

12. The fixture of claim 8 wherein the second lighting assembly is disposed at a distal end of the light bar.

13. A method of illuminating an area adjacent to a lighting fixture, comprising the steps of:
providing a light bar on the lighting fixture;
providing a first lighting assembly of a first wattage range disposed on the light bar for general illumination;
providing a second lighting assembly of a lower wattage range disposed on the light bar for special purposes illumination;
determining a desired illumination level;
selecting between the first and second lighting assemblies; and
activating the selected lighting assembly, thereby providing the desired illumination level.

14. The method of claim 13 wherein activating the first and second lighting assemblies provides a combination of general and special purposes illumination.

15. The method of claim 13 wherein activating neither the first nor second lighting assemblies provides no illumination.
